(19) United States
(12) Patent Application Publication
(10) Pub. No.: US 2025/0081037 A1
(43) Pub. Date: Mar. 6, 2025

(54) MULTI-LINK FRAGMENTATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US)

(21) Appl. No.: 18/814,221

(22) Filed: Aug. 23, 2024

Related U.S. Application Data
(60) Provisional application No. 63/536,638, filed on Sep. 5, 2023.

(51) Int. Cl. H04W 28/06; H04W 76/15; H04W 76/30; H04W 84/12

(52) U.S. Cl. CPC H04W 28/065; H04W 76/15; H04W 76/30; H04W 84/12

(57) ABSTRACT

Methods and apparatuses for fragmentation of data units by multi-link devices (MLDs) in a wireless local area network. A first MLD comprises first stations (STAs) and a processor operably coupled to the first STAs. The first STAs each comprise a transceiver configured to form a link with a corresponding second STA of a second MLD. The processor is configured to receive a data unit for transmission to the second MLD and to fragment the data unit into at least two fragments. The transceivers are further configured to transmit each of the fragments in separate frames to the corresponding second STAs of the second MLD over the corresponding links.

### CROSS-REFERENCE TO RELATED APPLICATION AND CLAIM OF PRIORITY

This application claims priority under 35 U.S.C. § 119(e) to U.S. Provisional Patent Application No. 63/536,638 filed on Sep. 5, 2023, which is hereby incorporated by reference in its entirety.

### TECHNICAL FIELD

This disclosure relates generally to multi-link operation in wireless communications systems that include multi-link devices. Embodiments of this disclosure relate to methods and apparatuses that facilitate fragmentation of data units in multi-link operation in a wireless local area network communications system.

### BACKGROUND

Wireless local area network (WLAN) technology allows devices to access the internet in the 2.4 gigahertz (GHz), 5 GHz, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA). With bandwidth aggregation across multiple channels/bands, MLO offers significant gain in throughput and latency performance compared to single link operation in the previous generation (802.11ax).

### SUMMARY

Embodiments of the present disclosure provide methods and apparatuses that facilitate fragmentation of data units in MLO in a WLAN.

In one embodiment, a first MLD is provided, comprising first stations (STAs) and a processor operably coupled to the first STAs. The first STAs each comprise a transceiver configured to form a link with a corresponding second STA of a second MLD. The processor is configured to receive a data unit for transmission to the second MLD, and to fragment the data unit into at least two fragments. The transceivers are further configured to transmit each of the fragments in separate frames to the corresponding second STAs of the second MLD over the corresponding links.

In another embodiment, a method of wireless communication performed by a first MLD that comprises first STAs is provided, wherein the first STAs each comprise a transceiver configured to form a link with a corresponding second STA of a second MLD. The method includes the steps of: receiving, by a processor of the first MLD, a data unit for transmission to the second MLD, fragmenting, by the processor, the data unit into at least two fragments, and transmitting, by the transceivers, each of the fragments in separate frames to the corresponding second STAs of the second MLD over the corresponding links.

In another embodiment, a second MLD is provided, comprising second STAs and a processor operably coupled to the STAs. The STAs each comprise a transceiver configured to form a link with a corresponding first STA of a first MLD, and to receive at least two fragments of a data unit in separate frames from the corresponding first STA of the first MLD over the corresponding link. The processor is configured to determine that each of the fragments correspond to the data unit transmitted from the first MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd”, or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example process of multi-link setup according to embodiments of the present disclosure;

FIG. 4 illustrates an example of MSDU fragmentation according to embodiments of the present disclosure;

FIG. 5 illustrates an example timing diagram for transmission of different fragments across the same link in MLO according to embodiments of the present disclosure;

FIG. 6 illustrates an example timing diagram for transmission of different fragments across different links in MLO according to embodiments of the present disclosure;

FIG. 7 illustrates an example timing diagram for duplication of fragments over different links in MLO according to embodiments of the present disclosure;

FIG. 8 illustrates an example timing diagram for transmission of fragments over different links due to link deletion in MLO according to embodiments of the present disclosure;

FIG. 9 illustrates an example transmission diagram for transmission of fragments over different links due to link deletion in MLO according to embodiments of the present disclosure;

FIG. 10 illustrates an example transmission diagram for duplication of fragments due to link deletion in MLO according to embodiments of the present disclosure;

FIG. 11 illustrates an example timing diagram for retransmission of fragments due to link deletion in MLO according to embodiments of the present disclosure;

FIG. 12 illustrates an example transmission diagram for retransmission of fragments due to link deletion in MLO according to embodiments of the present disclosure; and

FIG. 13 illustrates an example process for fragmentation of data units in MLO according to various embodiments of the present disclosure.

### DETAILED DESCRIPTION

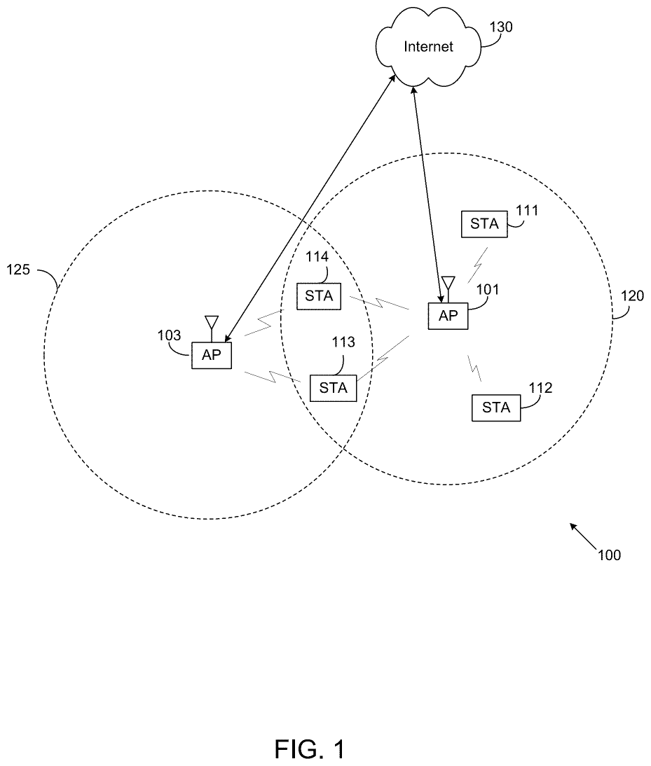

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that fragmentation is an important procedure in 802.11 frame transmission. In order to obey the transmission opportunity (TXOP) limit rules or restrictions on maximum length of the medium access control (MAC) protocol data unit (MPDU) or MAC service data unit (MSDU), the transmitter often needs to fragment the MSDU, aggregate MSDU (A-MSDU), MPDU, aggregate MPDU (A-MPDU), or management MPDU (MMPDU) across multiple frames or across multiple transmissions.

Embodiments of the present disclosure further recognize that it is currently not clear how fragmentation is performed in MLO. When a first MLD is transmitting to a second MLD over a first link established between the two MLDs, and the first MLD fragments a data unit (e.g., an MSDU or MMPDU), if, after sending a first fragment over the first link, the first link gets disabled, it is not clear how the remaining fragments will be transmitted. Additionally, embodiments of the present disclosure recognize that the behavior of the MLD at the receiving end is not well-defined.

Accordingly, embodiments of the present disclosure provide methods and apparatuses for facilitating fragmentation procedures in MLO.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP”, such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

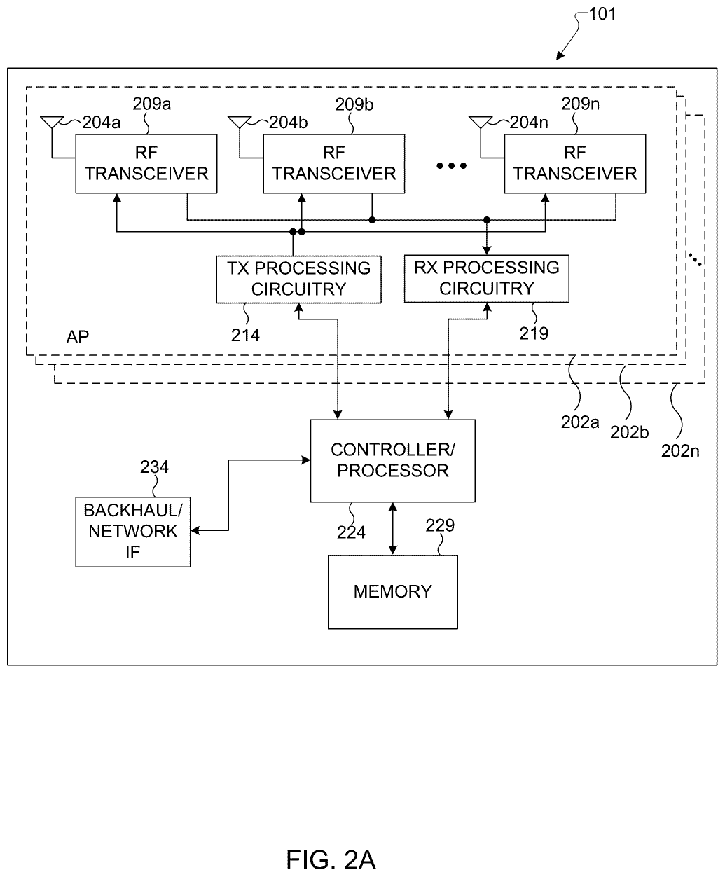

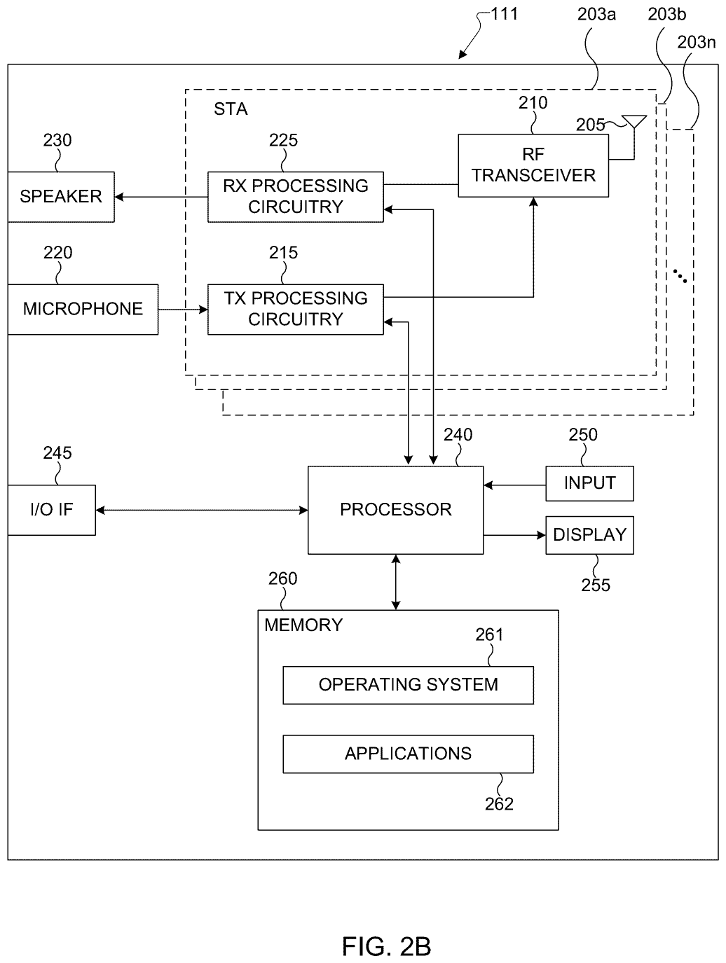

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate fragmentation of data units in MLO in a WLAN. In some embodiments, the controller/processor 240 includes at least one microprocessor or microcontroller.

The controller/processor 240 is also capable of executing other processes and programs resident in the memory 260, such as operations for facilitating fragmentation of data units in MLO in a WLAN. The controller/processor 240 can move data into or out of the memory 260 as required by an executing process. In some embodiments, the controller/processor 240 is configured to execute a plurality of applications 262, such as applications for facilitating fragmentation of data units in MLO in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

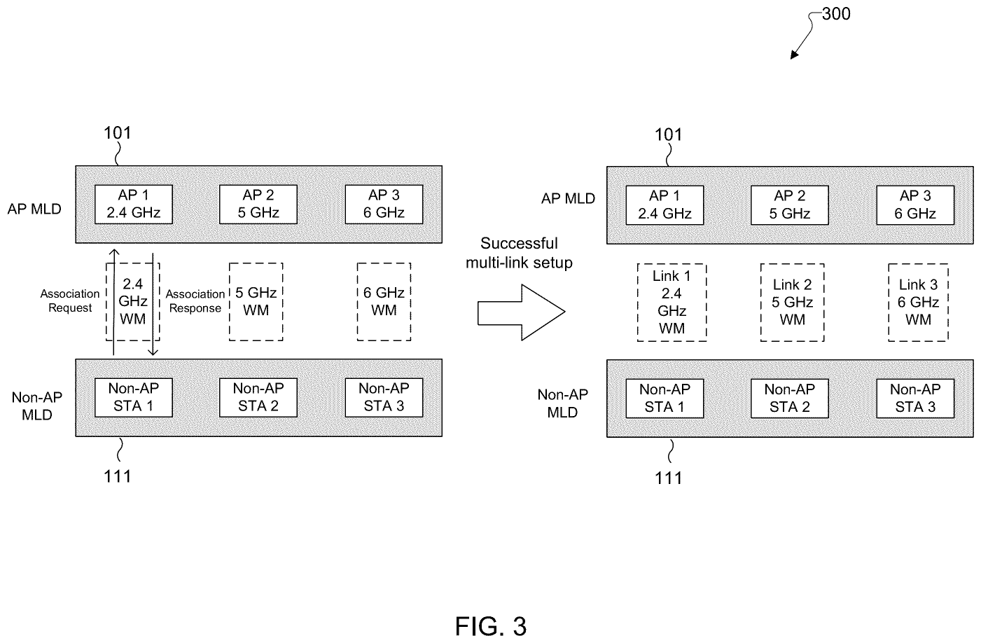

FIG. 3 illustrates an example process 300 of multi-link setup according to embodiments of the present disclosure. In this example, the AP MLD may be an AP MLD 101, and the non-AP MLD may be a non-AP MLD 111. Although the AP MLD 101 is illustrated with three affiliated APs (AP1, AP2, and AP3) and the non-AP MLD 111 is illustrated with three affiliated non-AP STAs (non-AP STA1, non-AP STA2, and non-AP STA3), it is understood that this process could be applied with suitable MLDs having any number of affiliated APs or STAs.

For ease of explanation, it is understood that references to an AP MLD and a non-AP MLD in further embodiments below refer to the AP MLD 101 and non-AP MLD 111, respectively.

In the example of FIG. 3, an exchange of Association Request frame and Association Response frame takes place over the 2.4 GHz link between the AP MLD and the non-AP MLD, where the setup is for establishing three links between the AP MLD and the non-AP MLD: one link on the 2.4 GHz band, a second link on the 5 GHz band, and a third link on the 6 GHz band. After the successful ML setup, the three links are established between the AP MLD and the non-AP MLD-Link 1 between AP1 and non-AP STA1, Link 2 between AP2 and non-AP STA2, and Link 3 between AP3 and non-AP STA3.

As noted above, it is currently unclear how fragmentation is to be performed in MLO. Accordingly, embodiments of the present disclosure provided herein below introduce procedures for fragmentation in MLO.

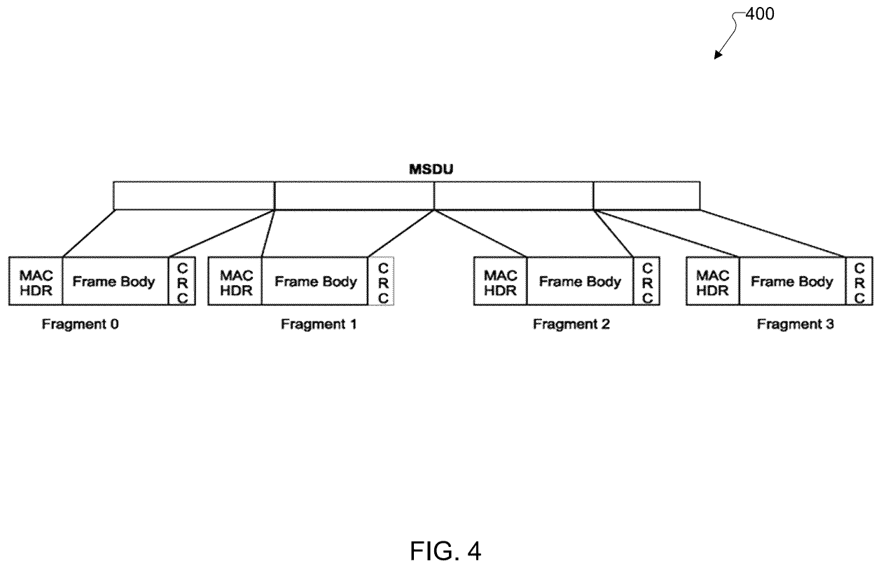

FIG. 4 illustrates an example 400 of MSDU fragmentation according to embodiments of the present disclosure. In this example, the MSDU is fragmented across 4 frames. For simplicity, an MSDU may be used herein as an example data unit type for the purposes of the disclosed fragmentation procedures for MLO. However, it is understood that any other suitable data unit (e.g., A-MSDU, MPDU, A-MPDU, or MMPDU) may be used with the procedures disclosed herein.

According to one embodiment, when a STA affiliated with an MLD fragments an MSDU or A-MSDU or MPDU or A-MPDU or MMPDU and sends a fragment of the MSDU or A-MSDU or MPDU or A-MPDU or MMPDU over a first link, then the MLD sends the remaining fragments of the MSDU or A-MSDU or MPDU or A-MPDU or MMPDU over the same link (i.e., the first link).

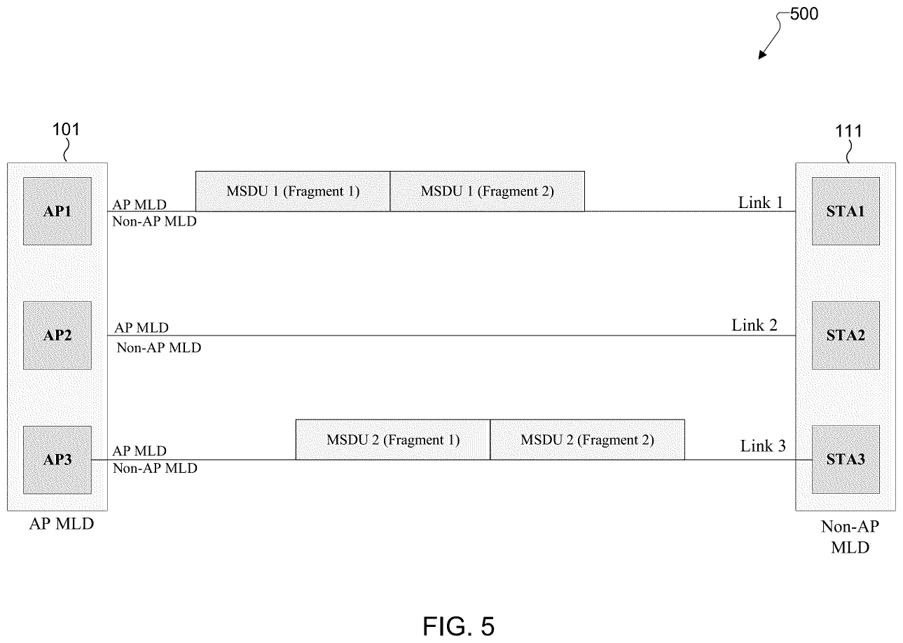

FIG. 5 illustrates an example timing diagram 500 for transmission of different fragments across the same link in MLO according to embodiments of the present disclosure. In this example, the AP MLD may be an AP MLD 101, and the non-AP MLD may be a non-AP MLD 111.

In the example of FIG. 5, AP1 affiliated with the AP MLD fragments an MSDU (MSDU 1) and sends a fragment of the MSDU over Link 1, then the AP MLD sends the remaining fragments of the MSDU over the same link (Link 1). AP3 affiliated with the AP MLD performs the same operation over Link 3 with MSDU 2.

According to one embodiment, when a STA affiliated with an MLD fragments an MSDU or A-MSDU or MPDU or A-MPDU or MMPDU and sends a fragment of the MSDU or A-MSDU or MPDU or A-MPDU or MMPDU over a first link, then the MLD can send the remaining fragments of the MSDU or A-MSDU or MPDU or A-MPDU or MMPDU over any enabled links.

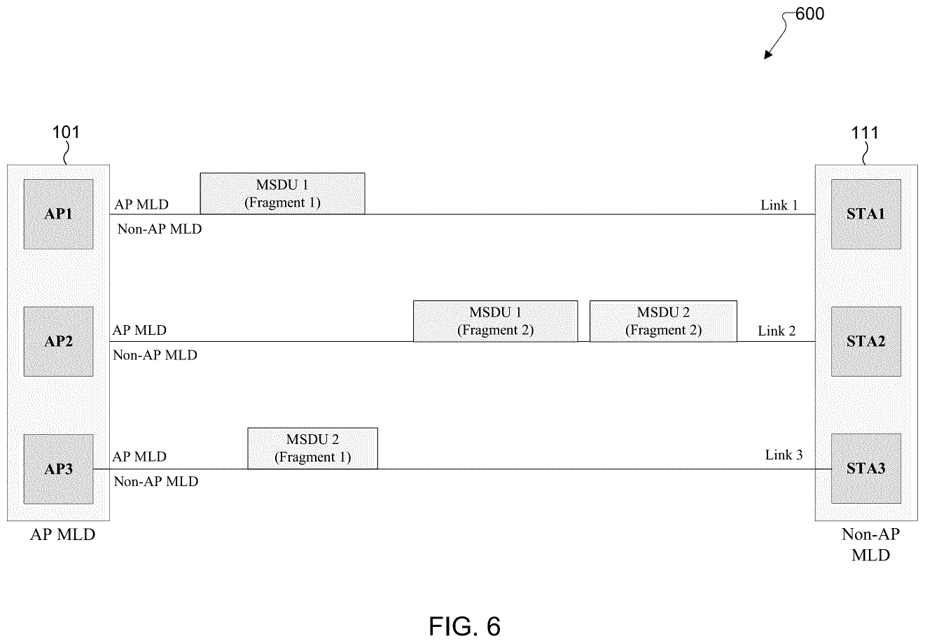

FIG. 6 illustrates an example timing diagram 600 for transmission of different fragments across different links in MLO according to embodiments of the present disclosure. In this example, the AP MLD may be an AP MLD 101, and the non-AP MLD may be a non-AP MLD 111.

In the example of FIG. 6, AP1 affiliated with the AP MLD fragments an MSDU (MSDU 1) and sends a fragment of MSDU 1 over Link 1, then the AP MLD sends the remaining fragments of MSDU 1 over another enabled link (Link 2). Likewise, AP3 affiliated with the AP MLD fragments MSDU 2 and sends a fragment of MSDU 2 over Link 3, then the AP MLD sends the remaining fragments of MSDU 2 over another enabled link (Link 2).

According to one embodiment, when a STA affiliated with an MLD fragments an MSDU or A-MSDU or MPDU or A-MPDU or MMPDU and sends a fragment of the MSDU or A-MSDU or MPDU or A-MPDU or MMPDU over a first link, then the MLD can duplicate the remaining fragments of the MSDU or A-MSDU or MPDU or A-MPDU or MMPDU and transmit them over all the enabled links.

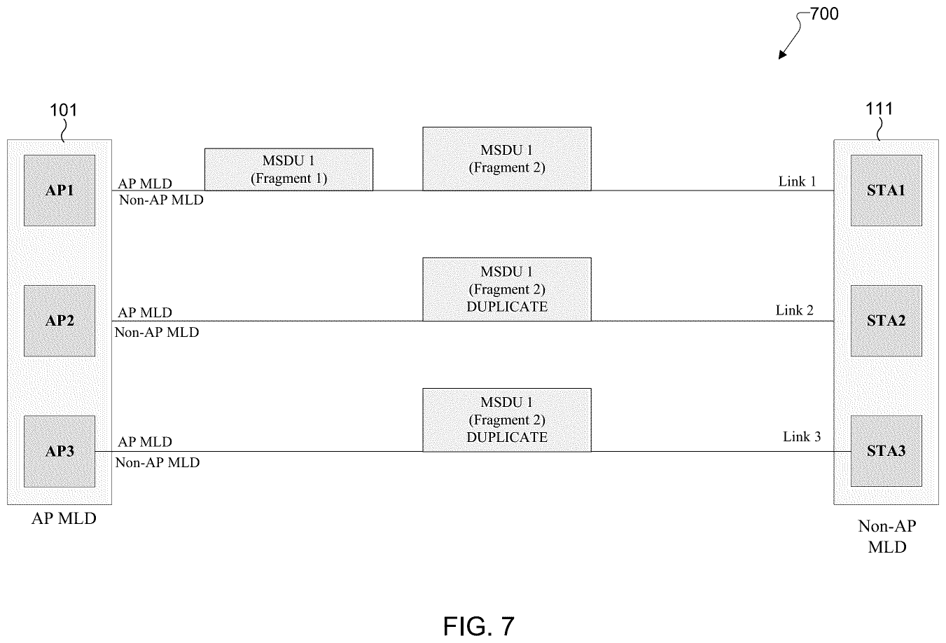

FIG. 7 illustrates an example timing diagram 700 for duplication of fragments over different links in MLO according to embodiments of the present disclosure. In this example, the AP MLD may be an AP MLD 101, and the non-AP MLD may be a non-AP MLD 111.

In the example of FIG. 7, AP1 affiliated with the AP MLD fragments an MSDU (MSDU 1) and sends a fragment of MSDU 1 over Link 1, then the AP MLD duplicates the remaining fragments of MSDU 1 and transmits them over all of the enabled links (Link 1, Link 2, and Link 3).

According to one embodiment, when an MLD transmits a fragment of an MSDU or A-MSDU or MPDU or A-MPDU or MMPDU over a first link and after sending that fragment the first link is disabled, deleted, or pending disablement or deletion, then the MLD can send the other fragments of the MSDU or A-MSDU or MPDU or A-MPDU or MMPDU over a second enabled link.

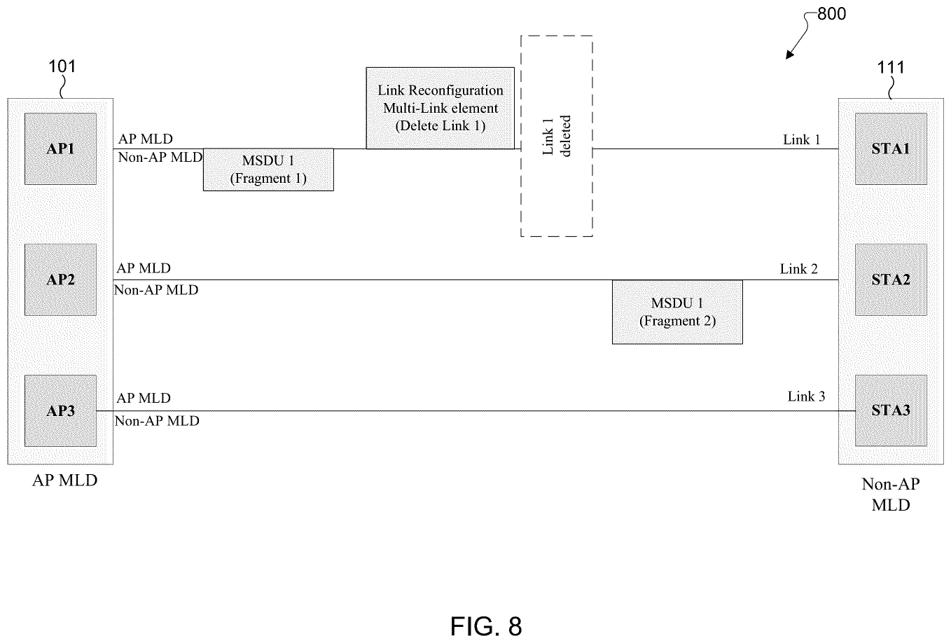

FIG. 8 illustrates an example timing diagram 800 for transmission of fragments over different links due to link deletion in MLO according to embodiments of the present disclosure. In this example, the AP MLD may be an AP MLD 101, and the non-AP MLD may be a non-AP MLD 111.

In the example of FIG. 8, STA1 affiliated with the non-AP MLD fragments an MSDU (MSDU 1) and sends a fragment of MSDU 1 over a first link (Link 1), then Link 1 is deleted (through action of the AP MLD). The non-AP MLD then sends the remaining fragments of MSDU 1 (Fragment 2 in this example) over another enabled link (Link 2). It is understood that the procedure of FIG. 8 may also be used in cases in which the first link (e.g., Link 1) is disabled rather than deleted.

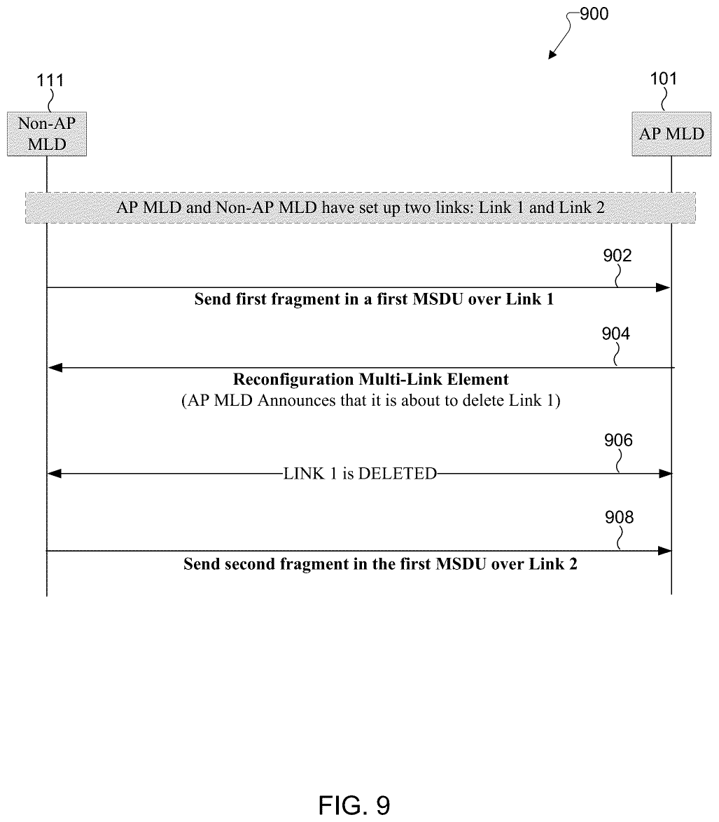

FIG. 9 illustrates an example transmission diagram 900 for transmission of fragments over different links due to link deletion in MLO according to embodiments of the present disclosure. In this example, the AP MLD may be an AP MLD 101, and the non-AP MLD may be a non-AP MLD 111. The transmission diagram 900 may correspond to the procedure performed in FIG. 8.

In the example of FIG. 9, the non-AP MLD fragments a first MSDU and sends a first fragment of the first MSDU over Link 1 (step 902), then the AP MLD announces (using a Reconfiguration Multi-Link Element) that Link 1 is pending deletion (step 904). After Link 1 is deleted (step 906), the non-AP MLD sends a second fragment of the first MSDU over another enabled link-Link 2 (step 908). It is understood that the procedure of FIG. 9 may also be used in cases in which the first link (e.g., Link 1) is disabled rather than deleted.

According to one embodiment, when an MLD transmits a fragment of an MSDU or A-MSDU or MPDU or A-MPDU or MMPDU over a first link and after sending that fragment the first link is disabled, deleted, or pending disablement or deletion, then the MLD can duplicate the other fragments of the MSDU or A-MSDU or MPDU or A-MPDU or MMPDU and send the other duplicate fragments over all the enabled links.

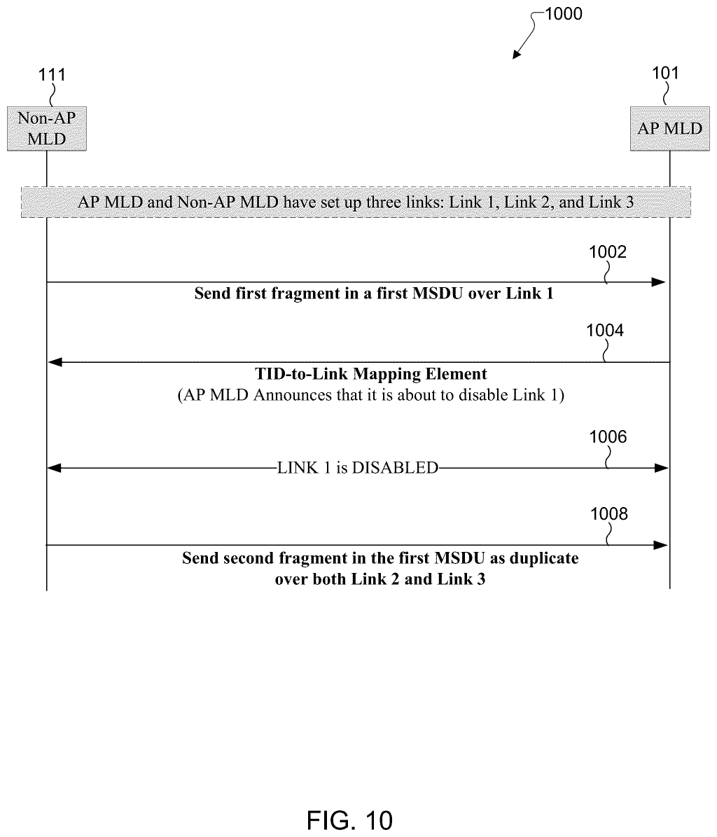

FIG. 10 illustrates an example transmission diagram 1000 for duplication of fragments due to link deletion in MLO according to embodiments of the present disclosure. In this example, the AP MLD may be an AP MLD 101, and the non-AP MLD may be a non-AP MLD 111.

In the example of FIG. 10, the non-AP MLD fragments a first MSDU and sends a first fragment of the first MSDU over a first link-Link 1 (step 1002)—then the AP MLD announces (using a TID-to-Link Mapping Element) that Link 1 is pending disablement (step 1004). After Link 1 is disabled (step 1006), the non-AP MLD sends a second fragment of the first MSDU as a duplicate over the other enabled links-Link 2 and Link 3 (step 1008)). It is understood that the procedure of FIG. 10 may also be used in cases in which the first link (e.g., Link 1) is deleted rather than disabled.

According to one embodiment, when an MLD transmits a fragment of an MSDU or A-MSDU or MPDU or A-MPDU or MMPDU over a first link and after sending that fragment the first link is disabled, deleted, or pending disablement or deletion, then the MLD can start a retransmission of the MSDU or A-MSDU or MPDU or A-MPDU or MMPDU on a second link. This retransmission may contain any previously sent fragments of the MSDU or A-MSDU or MPDU or A-MPDU or MMPDU transmitted over the first link. In such a case, the recipient MLD may receive the fragments (including the previously received fragments received on the first link) of the entire MSDU or A-MSDU or MPDU or A-MPDU or MMPDU on the second link.

In this case, according to one embodiment, the recipient MLD may flush out any previously received fragments of the MSDU or A-MSDU or MPDU or A-MPDU or MMPDU received on the first link (since the recipient MLD has received those fragments again on the second link). According to another embodiment, the recipient MLD may reorder the fragments received across multiple links.

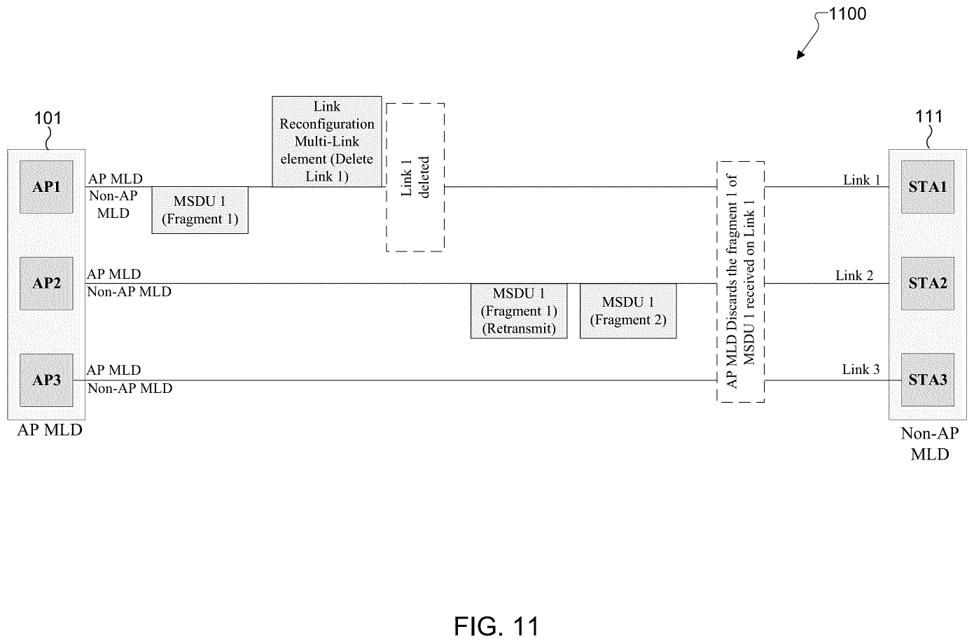

FIG. 11 illustrates an example timing diagram 1100 for retransmission of fragments due to link deletion in MLO according to embodiments of the present disclosure. In this example, the AP MLD may be an AP MLD 101, and the non-AP MLD may be a non-AP MLD 111.

In the example of FIG. 11, STA1 affiliated with the non-AP MLD fragments an MSDU (MSDU 1) and sends a fragment of MSDU 1 over a first link (Link 1), then Link 1 is deleted (through action of the AP MLD). The non-AP MLD then sends all fragments of MSDU 1 over another enabled link (Link 2)—that is, the non-AP MLD retransmits the previously-transmitted first fragment of MSDU 1 and then transmits the remaining fragments of MSDU 1 over Link 2. The AP MLD then discards the first fragment of MSDU 1 that was received over Link 1. It is understood that the procedure of FIG. 11 may also be used in cases in which the first link (e.g., Link 1) is disabled rather than deleted.

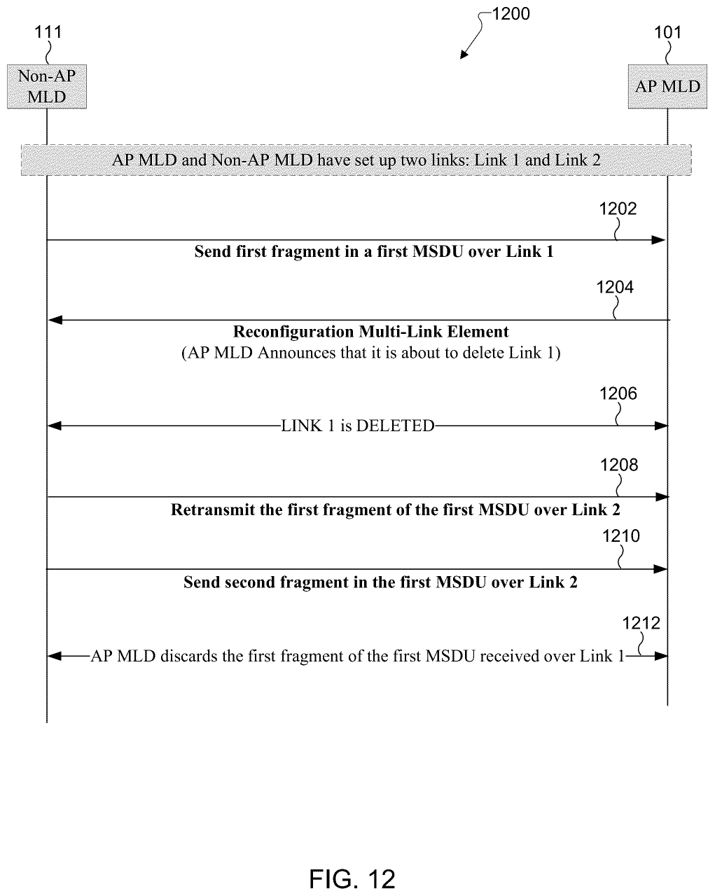

FIG. 12 illustrates an example transmission diagram 1200 for retransmission of fragments due to link deletion in MLO according to embodiments of the present disclosure. In this example, the AP MLD may be an AP MLD 101, and the non-AP MLD may be a non-AP MLD 111. The transmission diagram 1200 may correspond to the procedure performed in FIG. 11.

In the example of FIG. 12, the non-AP MLD fragments a first MSDU and sends a first fragment of the first MSDU over a first link-Link 1 (step 1202)—then the AP MLD announces (using a Reconfiguration Multi-Link Element) that Link 1 is pending deletion (step 1204). After Link 1 is deleted (step 1206), the non-AP MLD retransmits the first fragment of the first MSDU over another enabled link-Link 2 (step 1208)—then the non-AP MLD sends a second fragment of the first MSDU over Link 2 (step 1210). The AP MLD then discards the first fragment of MSDU 1 that was received over Link 1 (step 1212). It is understood that the procedure of FIG. 12 may also be used in cases in which the first link (e.g., Link 1) is disabled rather than deleted.

According to one embodiment, an MLD may transmit a fragment over a first link before the timer for link deletion or link disablement reaches zero for the first link.

It is understood that the embodiments disclosed herein above are examples, and various changes may be made without departing from the scope of the present disclosure. For example, although various embodiments describe sending one fragment (e.g., a first fragment) over a first link before sending one fragment (e.g., a second fragment) over another link, it is understood that any number of fragments may be sent over the first link, and that any number of remaining fragments may be sent over the other link.

Additionally, although above embodiments discuss transmissions between an AP MLD and a non-AP MLD, all of the above embodiments may be performed with either type of MLD on the transmitting and receiving sides. That is, the above embodiments may apply to transmissions from AP MLD to non-AP MLD, from non-AP MLD to AP MLD, from AP MLD to AP MLD, and from non-AP MLD to non-AP MLD.

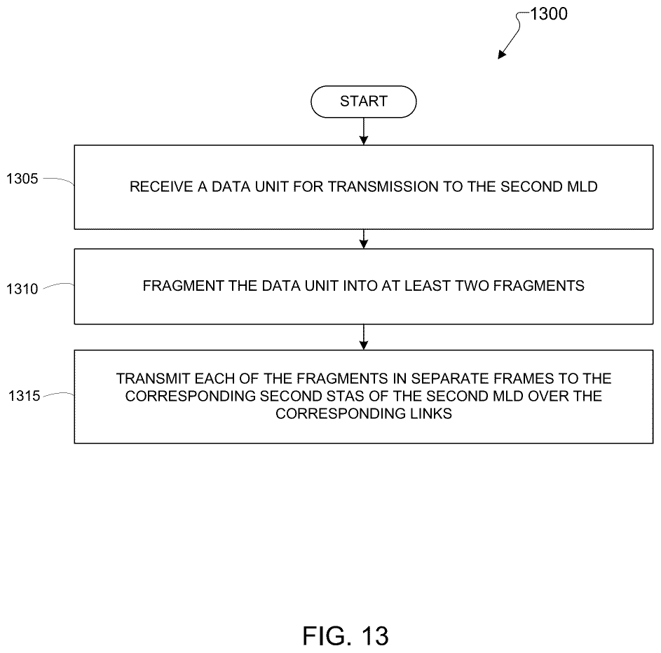

FIG. 13 illustrates an example process 1300 for fragmentation of data units in MLO according to various embodiments of the present disclosure. The process 1300 of FIG. 13 is discussed as being performed by a transmitting MLD, but it is understood that a corresponding receiving MLD performs a corresponding process. Additionally, for convenience the process of FIG. 13 is discussed as being performed by a first WI-FI MLD comprising a plurality of first STAs that each comprise a transceiver configured to form a link with a corresponding second STA of a second MLD. For example, the first MLD and second MLD could be, respectively, an AP MLD and a non-AP MLD, a non-AP MLD and an AP MLD, both could be non-AP MLDs, or both could be AP MLDs. However, it is understood that any suitable wireless communication device could perform this process.

Referring to FIG. 13, at step 1305 a processor of the first MLD may receive a data unit for transmission to the second MLD. The data unit may be an MPDU, MSDU, A-MSDU, A-MPDU, MMPDU, or any other type of data unit.

The processor of the first MLD then fragments the data unit into at least two fragments (step 1310). For example, the data unit may exceed the maximum length that may be transmitted in a single WI-FI frame, and the processor thus breaks the data unit down into fragments which each individually satisfy the maximum length restrictions.

The transceivers of the first STAs then transmit each of the fragments in separate frames to the corresponding second STAs of the second MLD over the corresponding links (step 1315). This step may be performed in various ways.

In some embodiments, one of the transceivers transmits each of the fragments to the corresponding second STA over the corresponding link. That is, all of the fragments are transmitted over one link.

In some embodiments, one of the transceivers transmits at least one of the fragments to the corresponding second STA over the corresponding first link, and at least one of the other transceivers transmits each of the other fragments to the corresponding second STA over one of the corresponding other links. That is some of the fragments are transmitted over one link, and the remaining fragments are transmitted over any other enabled link.

In some embodiments, a first of the transceivers transmits at least one of the fragments to the corresponding second STA over the corresponding first link, then the first transceiver transmits each of the other fragments to the corresponding second STA over the corresponding first link while the other transceivers transmit a duplicate of each of the other fragments to the corresponding second STAs over one of the corresponding other links. That is, all of the fragments are transmitted over the first link, and additionally duplicates of some of the fragments are sent over the other enabled links.

In some embodiments, one of the transceivers transmits at least one of the fragments to the corresponding second STA over the corresponding first link. After transmission of the at least one fragment, the processor determines that the first link will be disabled or deleted, and at least one of the other transceivers then transmits each of the other fragments to the corresponding second STA over one of the corresponding other links. That is, after some of the fragments are transmitted over the first link, the first link is disabled or deleted, and the remaining fragments are then transmitted over any other enabled link.

In some embodiments, one of the transceivers transmits at least one of the fragments to the corresponding second STA over the corresponding first link. After transmission of the at least one fragment, the processor determines that the first link will be disabled or deleted, and at least one of the other transceivers then transmits a duplicate of each of the other fragments to the corresponding second STAs over one of the corresponding other links. That is, after some of the fragments are transmitted over the first link, the first link is disabled or deleted, and duplicates of the remaining fragments are then transmitted over any other enabled link.

In some embodiments, one of the transceivers transmits at least one of the fragments to the corresponding second STA over the corresponding first link. After transmission of the at least one fragment, the processor determines that the first link will be disabled or deleted, and at least one of the other transceivers then retransmits the at least one fragment to the corresponding second STA over one of the corresponding other links and transmits each of the other fragments to the corresponding second STA over the corresponding other link. That is, after some of the fragments are transmitted over the first link, the first link is disabled or deleted, then the previously-transmitted fragments are retransmitted over any other enabled link and the remaining (yet-to-be transmitted) fragments are then transmitted over any of the other enabled links.

For the various embodiments in which a link is deleted or disabled, if the first MLD is an AP MLD, then the first MLD itself may determine to disable or delete the link. If the first MLD is a non-AP MLD, then the first MLD may receive a frame from an associated AP MLD including, e.g., a Reconfiguration Multi-Link Element or TID-to-Link Mapping Element indicating that the first link is to be deleted or disabled.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A first multi-link device (MLD) comprising:
first stations (STAs) each comprising a transceiver configured to form a link with a corresponding second STA of a second MLD; and
a processor operably coupled to the first STAs, the processor configured to:
receive a data unit for transmission to the second MLD, and
fragment the data unit into at least two fragments,
wherein the transceivers are further configured to transmit each of the fragments in separate frames to the corresponding second STAs of the second MLD over the corresponding links.

2. The first MLD of claim 1, wherein one of the transceivers is configured to transmit each of the fragments to the corresponding second STA over the corresponding link.

3. The first MLD of claim 1, wherein:
one of the transceivers is configured to transmit at least one of the fragments to the corresponding second STA over the corresponding first link, and
at least one of the other transceivers is configured to transmit each of the other fragments to the corresponding second STA over one of the corresponding other links.

4. The first MLD of claim 1, wherein:
a first of the transceivers is configured to transmit at least one of the fragments to the corresponding second STA over the corresponding first link,
the first transceiver is further configured to transmit each of the other fragments to the corresponding second STA over the corresponding first link, and
the other transceivers are configured to transmit a duplicate of each of the other fragments to the corresponding second STAs over one of the corresponding other links.

5. The first MLD of claim 1, wherein:
one of the transceivers is configured to transmit at least one of the fragments to the corresponding second STA over the corresponding first link,
the processor is further configured to determine, after transmission of the at least one fragment, that the first link will be disabled or deleted, and
at least one of the other transceivers is configured to transmit each of the other fragments to the corresponding second STA over one of the corresponding other links.

6. The first MLD of claim 1, wherein:
one of the transceivers is configured to transmit at least one of the fragments to the corresponding second STA over the corresponding first link,
the processor is further configured to determine, after transmission of the at least one fragment, that the first link will be disabled or deleted, and
the other transceivers are configured to transmit a duplicate of each of the other fragments to the corresponding second STAs over one of the corresponding other links.

7. The first MLD of claim 1, wherein:
one of the transceivers is configured to transmit at least one of the fragments to the corresponding second STA over the corresponding first link,
the processor is further configured to determine, after transmission of the at least one fragment, that the first link will be disabled or deleted, and
at least one of the other transceivers is configured to:
retransmit the at least one fragment to the corresponding second STA over one of the corresponding other links; and
transmit each of the other fragments to the corresponding second STA over the corresponding other link.

8. A method of wireless communication performed by a first multi-link device (MLD), the method comprising:
receiving, by the first MLD, a data unit for transmission to a second MLD, wherein the first MLD comprises first stations (STAs) each comprising a transceiver configured to form a link with a corresponding second STA of the second MLD;
fragmenting, by the first MLD, the data unit into at least two fragments; and
transmitting, by the transceivers, each of the fragments in separate frames to the corresponding second STAs of the second MLD over the corresponding links.

9. The method of claim 8, wherein transmitting, by the transceivers, each of the fragments comprises transmitting, by one of the transceivers, each of the fragments to the corresponding second STA over the corresponding link.

10. The method of claim 8, wherein transmitting, by the transceivers, each of the fragments comprises:
transmitting, by one of the transceivers, at least one of the fragments to the corresponding second STA over the corresponding first link; and
transmitting, by at least one of the other transceivers, each of the other fragments to the corresponding second STA over one of the corresponding other links.

11. The method of claim 8, wherein transmitting, by the transceivers, each of the fragments comprises:
transmitting, by a first of the transceivers, at least one of the fragments to the corresponding second STA over the corresponding first link;
transmitting, by the first transceiver, each of the other fragments to the corresponding second STA over the corresponding first link; and
transmitting, by the other transceivers, a duplicate of each of the other fragments to the corresponding second STAs over one of the corresponding other links.

12. The method of claim 8, wherein:
transmitting, by the transceivers, each of the fragments comprises transmitting, by one of the transceivers, at least one of the fragments to the corresponding second STA over the corresponding first link,
the method further comprises determining, after transmission of the at least one fragment, that the first link will be disabled or deleted, and
transmitting, by the transceivers, each of the fragments further comprises transmitting, by at least one of the other transceivers, each of the other fragments to the corresponding second STA over one of the corresponding other links.

13. The method of claim 8, wherein:
transmitting, by the transceivers, each of the fragments comprises transmitting, by one of the transceivers, at least one of the fragments to the corresponding second STA over the corresponding first link,
the method further comprises determining, after transmission of the at least one fragment, that the first link will be disabled or deleted, and
transmitting, by the transceivers, each of the fragments further comprises transmitting, by at least one of the other transceivers, a duplicate of each of the other fragments to the corresponding second STAs over one of the corresponding other links.

14. The method of claim 8, wherein:
transmitting, by the transceivers, each of the fragments comprises transmitting, by one of the transceivers, at least one of the fragments to the corresponding second STA over the corresponding first link,
the method further comprises determining, after transmission of the at least one fragment, that the first link will be disabled or deleted, and
transmitting, by the transceivers, each of the fragments further comprises:
retransmitting, by at least one of the other transceivers, the at least one fragment to the corresponding second STA over one of the corresponding other links; and
transmitting, by the at least one of the other transceivers, each of the other fragments to the corresponding second STA over the corresponding other link.

15. A second multi-link device (MLD) comprising:
second stations (STAs) each comprising a transceiver configured to:
form a link with a corresponding first STA of a first MLD, and
receive at least two fragments of a data unit in separate frames from the corresponding first STA of the first MLD over the corresponding link; and
a processor operably coupled to the second STAs, the processor configured to determine that each of the fragments correspond to the data unit transmitted from the first MLD.

16. The second MLD of claim 15, wherein one of the transceivers is configured to receive each of the fragments from the corresponding first STA over the corresponding link.

17. The second MLD of claim 15, wherein:
one of the transceivers is configured to receive at least one of the fragments from the corresponding first STA over the corresponding first link, and
at least one of the other transceivers is configured to receive each of the other fragments from the corresponding first STA over one of the corresponding other links.

18. The second MLD of claim 15, wherein:
a first of the transceivers is configured to receive at least one of the fragments from the corresponding first STA over the corresponding first link,
the first transceiver is further configured to receive each of the other fragments from the corresponding first STA over the corresponding first link, and
the other transceivers are configured to receive a duplicate of each of the other fragments from the corresponding first STAs over one of the corresponding other links.

19. The second MLD of claim 15, wherein:
one of the transceivers is configured to receive at least one of the fragments from the corresponding first STA over the corresponding first link,
the processor is further configured to determine, after reception of the at least one fragment, that the first link will be disabled or deleted, and
at least one of the other transceivers is configured to receive each of the other fragments from the corresponding first STA over one of the corresponding other links.

20. The second MLD of claim 15, wherein:
one of the transceivers is configured to receive at least one of the fragments from the corresponding first STA over the corresponding first link,
the processor is further configured to determine, after reception of the at least one fragment, that the first link will be disabled or deleted, and
the other transceivers are configured to receive a duplicate of each of the other fragments from the corresponding first STAs over one of the corresponding other links.

21. The second MLD of claim 15, wherein:
one of the transceivers is configured to receive at least one of the fragments from the corresponding first STA over the corresponding first link,
the processor is further configured to determine, after reception of the at least one fragment, that the first link will be disabled or deleted, and
at least one of the other transceivers is configured to:
receive a retransmission of the at least one fragment from the corresponding first STA over one of the corresponding other links; and
receive each of the other fragments from the corresponding first STA over the corresponding other link.
